(19) United States
(12) Patent Application Publication
(10) Pub. No.: US 2014/0317737 A1
(43) Pub. Date: Oct. 23, 2014

(54) HYPERVISOR-BASED INTRUSION PREVENTION PLATFORM AND VIRTUAL NETWORK INTRUSION PREVENTION SYSTEM

(71) Applicant: KOREA INTERNET & SECURITY AGENCY, Seoul (KR)

(72) Inventors: YOUNG-SANG SHIN, Seoul (KR); II-Ahn Cheong, Seoul (KR); Seul-Gi Lee, Seoul (KR); Mi-Yeon Yoon, Seoul (KR); Tong-Wook Hwang, Seoul (KR); Kyung-Ho Son, Seoul (KR)

(73) Assignee: Korea Internet & Security Agency, Seoul (KR)

(21) Appl. No.: 13/871,264

(22) Filed: Apr. 26, 2013

(30) Foreign Application Priority Data
Apr. 22, 2013 (KR) 10-2013-0044139

(51) Int. Cl. H04L 29/06

(52) U.S. Cl. CPC H04L 63/1408
USPC 726/23

(57) ABSTRACT

Hypervisor-based intrusion prevention platform is provided. The hypervisor-based intrusion prevention platform comprises a virtual network intrusion prevention system (vIPS) framework which obtains internal information of a virtualization system from a hypervisor and performs security control on the hypervisor in response to the result of intrusion detection carried out by using the internal information of the virtualization system, a hypervisor security application programming interface (API) module which provides an API used by the vIPS framework to access the hypervisor, an administrator account management and authentication module which manages an administrator account of a vIPS and authenticates the administrator account, an environment setting management module which manages environment setting values of modules within the vIPS, and an external interface module which provides an interface for system control and security control.

### RELATED APPLICATION

This application claims priority from Korean Patent Application No. 10-2013-0044139 filed on Apr. 22, 2013 in the Korean Intellectual Property Office, the disclosure of which is incorporated herein by reference in its entirety.

### BACKGROUND OF THE INVENTION

1. Field of the Invention

The present invention relates to a hypervisor-based intrusion prevention platform and virtual network intrusion prevention system.

2. Description of the Related Art

A hypervisor is a piece of software that enables operating systems (OS) of virtual machines to share physical resources such as CPU, memory, storage, etc. A virtual switch (vSwitch) is a software switch that exists inside the hypervisor and allows the virtual machines to communicate with each other. A virtualization system realized using the hypervisor is vulnerable to security threats including address resolution protocol (ARP) spoofing eavesdropping or intrusion on the virtual machines, and resource hogging and depletion through malicious hypercalls.

### SUMMARY OF THE INVENTION

Aspects of the present invention provide a hypervisor-based intrusion prevention platform and virtual network intrusion prevention system (vIPS) which can detect a virtual network-based attack on a virtualization system for cloud computing.

Aspects of the present invention also provide a hypervisor-based intrusion prevention platform and vIPS which can detect a virtual resource depletion attack on a virtualization system for cloud computing.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a hypervisor-based intrusion prevention platform comprising, a virtual network intrusion prevention system (vIPS) framework which obtains internal information of a virtualization system from a hypervisor and performs security control on the hypervisor in response to the result of intrusion detection carried out by using the internal information of the virtualization system, a hypervisor security application programming interface (API) module which provides an API used by the vIPS framework to access the hypervisor, an administrator account management and authentication module which manages an administrator account of a vIPS and authenticates the administrator account, an environment setting management module which manages environment setting values of modules within the vIPS, and an external interface module which provides an interface for system control and security control.

According to another aspect of the present invention, there is provided a hypervisor-based vIPS comprising, intrusion detection modules which perform intrusion detection by using internal information of a virtual machine, internal information of a hypervisor, and a virtual network packet of a virtualization system, and a hypervisor-based intrusion prevention platform which provides the internal information of the virtual machine, the internal information of the hypervisor and the virtual network packet of the virtualization system to the intrusion detection modules and receives the result of intrusion detection from the intrusion detection modules, wherein the hypervisor-based intrusion prevention platform comprises, a vIPS framework which obtains the internal information of the virtual machine, the internal information of the hypervisor and the virtual network of the virtualization system from the hypervisor and performs operation control of the virtual machine and rate control of virtual network traffic on the hypervisor in response to the result of intrusion detection, a hypervisor security API module which provides APIs used by the vIPS framework to access the hypervisor, an administrator account management and authentication module which manages an administrator account of the vIPS and authenticates the administrator account, an environment setting management module which manages environment setting values of modules within the vIPS and an external interface module which provides an interface for system control and security control.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a cloud environment security system according to an embodiment of the present invention;

FIG. 2 is a detailed block diagram of a hypervisor-based virtual network intrusion prevention system (vIPS) shown in FIG. 1;

FIG. 3 is a block diagram illustrating a structure in which a hypervisor security application programming interface (API) module of FIG. 2 performs security control;

FIG. 4 is a detailed block diagram of a vIPS framework shown in FIG. 2;

FIG. 5 is a detailed block diagram of an introspection information collection and analysis module shown in FIG. 4;

FIG. 6 is a detailed block diagram of a policy and signature management module shown in FIG. 4;

FIG. 7 is a detailed block diagram of an intrusion response module shown in FIG. 4;

FIG. 8 is a detailed block diagram of an intrusion prevention system (IPS) control module shown in FIG. 4;

FIG. 9 is a detailed block diagram of a logging module shown in FIG. 4;

FIG. 10 is a detailed block diagram of an administrator account management and authentication module shown in FIG. 2;

FIG. 11 is a detailed block diagram of an environment setting management module shown in FIG. 2;

FIG. 12 is a diagram illustrating the operations of intrusion detection modules shown in FIG. 2;

FIG. 13 is a diagram illustrating the flow of virtual network packets in an inline mode;

FIG. 14 is a diagram illustrating the flow of virtual network packets in a tap mode;

FIG. 15 is a diagram illustrating the detailed operations of a stateful firewall module and a network-based IPS (NIPS) module in the inline mode;

FIG. 16 is a diagram illustrating the detailed operations of the stateful firewall module and the NIPS module in the tap mode;

FIG. 17 is a detailed block diagram of the stateful firewall module shown in FIG. 2;

FIG. 18 is a detailed block diagram of the NIPS module shown in FIG. 2;

FIG. 19 is a detailed block diagram of a virtual resource depletion attack detection module shown in FIG. 2; and

FIG. 20 is a detailed block diagram of an external interface module shown in FIG. 2.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

The present invention will now be described more fully with reference to the accompanying drawings, in which exemplary embodiments of the invention are shown.

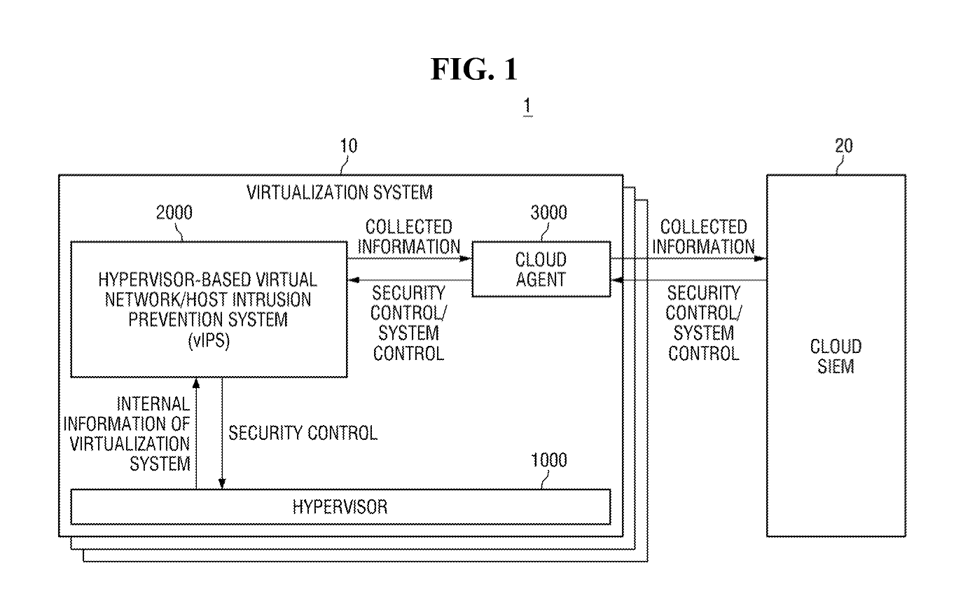

FIG. 1 is a block diagram of a cloud environment security system 1 according to an embodiment of the present invention.

Referring to FIG. 1, the cloud environment security system 1 according to the current embodiment includes a virtualization system 10 and a cloud security information and event management (cloud SIEM) system 20.

The virtualization system 10 runs a plurality of virtual machines on a single physical machine. The virtual machines may operate independently and run different operating systems (OS). The virtualization system 10 includes a hypervisor 1000, a hypervisor-based virtual network intrusion prevention system (vIPS) 2000, and a cloud agent 3000.

The hypervisor 1000 distributes and schedules physical resources (e.g., CPU, memory, storage, network, etc.) to the virtual machines so as to enable the virtual machines to run on the virtualization system 10. The hypervisor 1000 may access the virtual machines within the virtualization system 10 and resources being used by the virtual machines. The hypervisor 1000 may include a software virtual switch (vSwitch) which relays virtual network packets for communication between the virtual machines and a firewall packet filter which filters the virtual network packets according to preset rules. The hypervisor 1000 may also be called a virtual machine monitor (VMM).

The vIPS 2000 obtains internal information of the virtualization system 10 from the hypervisor 1000 and performs virtual network intrusion detection by using the obtained information. The vIPS 2000 provides a security control command to the hypervisor 1000 in order to respond to an intrusion. The internal information of the virtualization system 10 may include internal information of the virtual machines, internal information of the hypervisor 1000, and virtual network packets within the virtualization system 10. The security control by the vIPS 2000 may include operation control of the virtual machines and rate control of virtual network traffic.

The cloud STEM system 20 collects information of the virtualization system 10 and security events from a plurality of vIPS 2000 and performs security information and event management on the entire cloud infrastructure. The cloud SIEM system 20 provides a security control command and a relevant security policy to each vIPS 2000 in order to respond to an intrusion. The cloud SIEM system 20 provides a system control command for the operation control and environment variable management of the vIPS 2000 to each vIPS 2000. The information collected by the cloud SIEM system 20 may include status information of the virtual machines, status information of the hypervisor 1000, physical resource specification information of the virtualization system 10, summary information of network traffic in the virtualization system 10, security events, and a system log of each vIPS 2000. The security control by the cloud SIEM system 20 may include operation control of the virtual machines, rate control of virtual network traffic, an attack response policy, and a policy and signature rule set. The system control may include operation control of each vIPS 2000, environment variable setting and query of the vIPS 2000, etc.

The cloud agent 3000 runs on the virtualization system 10 and relays communication between the cloud SIEM system 20 and the vIPS 2000. The cloud agent 3000 collects the information of the virtualization system 10 and security events from the vIPS 2000 and sends the collected information to the cloud SIEM system 20. In addition, the cloud agent 3000 receives a security control command and a system control command from the cloud SIEM system 20 and sends the received commands to the vIPS 2000.

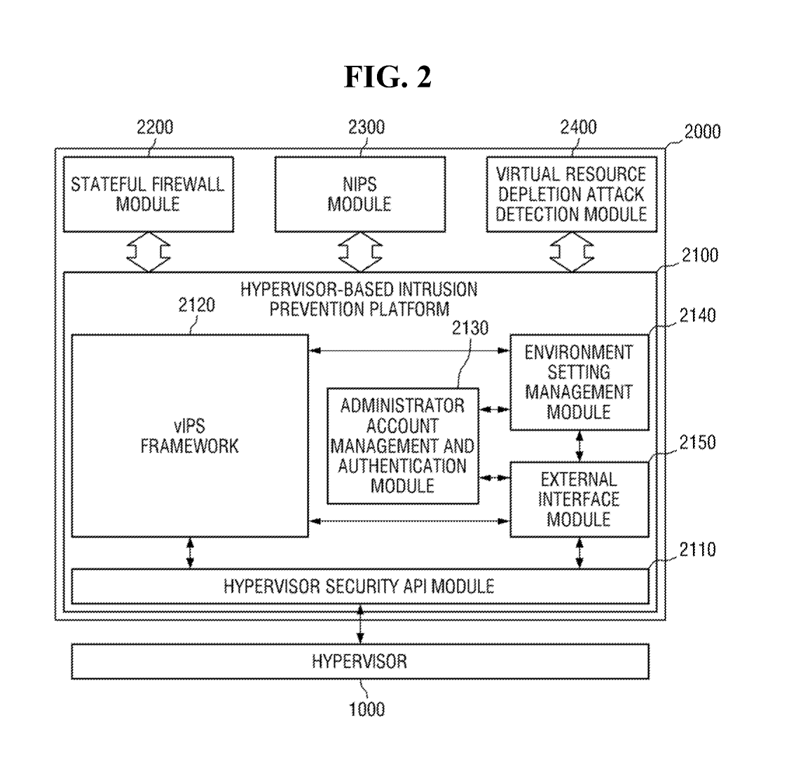

FIG. 2 is a detailed block diagram of the vIPS 2000 shown in FIG. 1. Referring to FIG. 2, the vIPS 2000 includes a hypervisor-based intrusion prevention platform 2100, a stateful firewall module 2200, a network-based IPS (NIPS) module 2300, a virtual resource depletion attack detection module 2400.

The hypervisor-based intrusion prevention platform 2100 controls the operations of the stateful firewall module 2200, the NIPS module 2300 and the virtual resource depletion attack detection module 2400 which are at a level above the hypervisor-based intrusion prevention platform 2100. The hypervisor-based intrusion prevention platform 2100 offers an interface which provides information needed for the above modules to perform intrusion detection and an interface which receives the result of intrusion detection from these modules. The hypervisor-based intrusion prevention platform 2100 includes a hypervisor security application programming interface (API) module 2110, a vIPS framework 2120, an administrator account management and authentication module 2130, an environment setting management module 2140, and an external interface module 2150.

The hypervisor security API module 2110 provides APIs (e.g., XenSecurity API) used by the modules of the hypervisor-based intrusion prevention platform 2100 to access the internal information of the virtualization system 10 through the hypervisor 1000 and issue a security control command to the hypervisor 1000. That is, the hypervisor security API module 2110 is a module that provides an abstraction for security-related access to the hypervisor 1000.

The hypervisor security API module 2110 receives the internal information of the virtualization system 10 required by internal modules of the vIPS framework 2120 from the hypervisor 1000 and performs security control on the virtualization system 10 on the hypervisor 1000.

The vIPS framework 2120 is a set of common modules essential to construct an IPS and a firewall in the vIPS 2000. The vIPS framework 2120 provides common functions and structures needed for the higher-level intrusion detection modules (i.e., the stateful firewall module 2200, the NIPS module 2300, and the virtual resource depletion attack detection module 2400) to perform access control, intrusion detection, and a response action.

The administrator account management and authentication module 2130 manages an account of a user (i.e., an administrator of the vIPS 2000) and authenticates the account.

The environment setting management module 2140 manages environment setting values. The environment setting values of all modules are allowed to be accessed (written or read) only through the environment setting management module 2140, so that the vIPS 2000 can always operate according to the latest environment setting values.

The external interface module 2150 provides an interface for system control and security control of the vIPS 2000.

The intrusion detection modules (i.e., the stateful firewall module 2200, the NIPS module 2300, and the virtual resource depletion attack detection module 2400) receive information required for intrusion detection and access control (e.g., the internal information of the virtual machines, the internal information of the hypervisor 1000, virtual network packets, etc.) from the hypervisor-based intrusion prevention platform 2100 and perform intrusion detection based on the received information. The stateful firewall module 2200 functions as a stateful firewall engine. The NIPS module 2300 functions as a NIPS engine. The virtual resource depletion attack detection module 2400 detects a resource depletion attack on virtual resources.

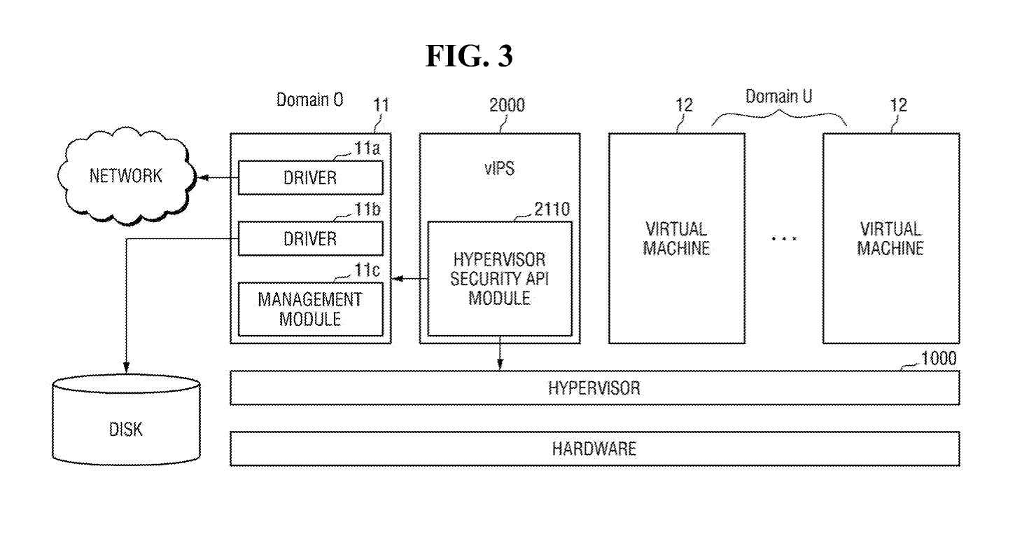

FIG. 3 is a block diagram illustrating a structure in which the hypervisor security API module 2110 of FIG. 2 performs security control.

Referring to FIG. 3, the hypervisor security API module 2110 accesses the hypervisor 1000 and domain 0 (11) in order to perform security control.

The virtual machines of the virtualization system 10 may be divided into the domain 0 (11) and domain U (12). The domain 0 (11) is a management domain that has privileges and manages the domain U (12) used as user virtual machines. The hypervisor 1000 includes no drivers. Instead, the domain 0 (11) includes a network driver 11a which communicates with a network and a device driver 11b which handles physical devices (e.g., a disk). In addition, the domain 0 (11) includes a management module 11c which controls each domain U (12).

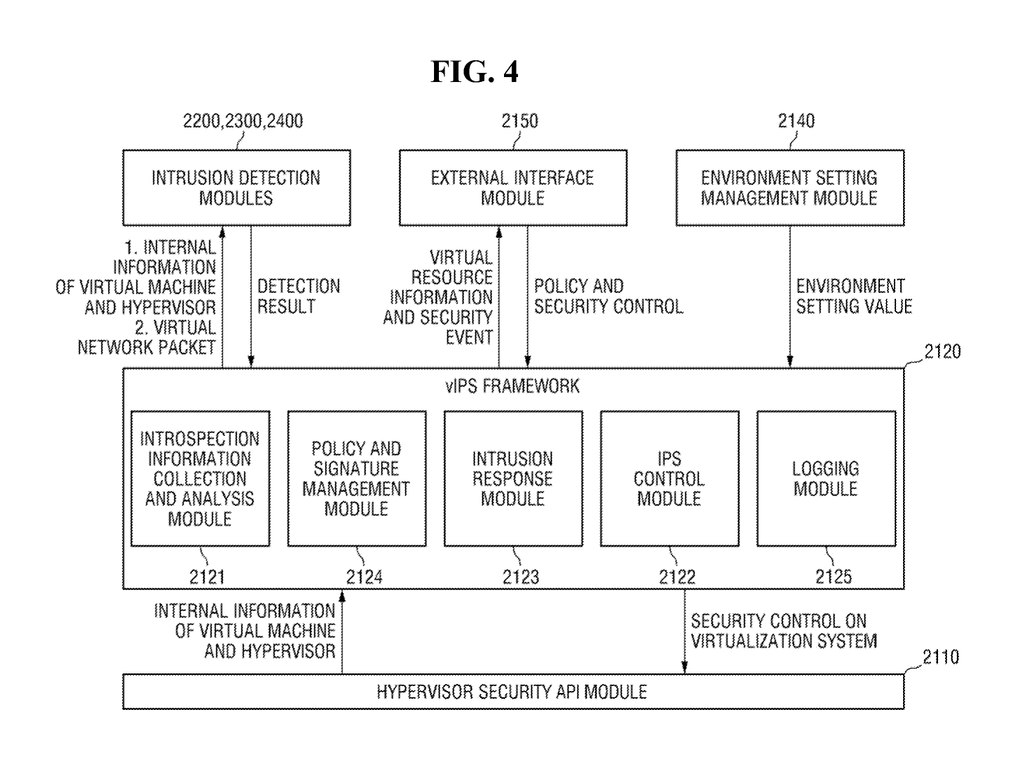

FIG. 4 is a detailed block diagram of the vIPS framework 212 shown in FIG. 2.

Referring to FIG. 4, the vIPS framework 2120 provides necessary information for intrusion detection to the intrusion detection modules and receives the result of intrusion detection from the intrusion detection modules. The vIPS framework 2120 provides resource information of the virtualization system 10, which is required by the cloud agent 3000, and security events that occur in the vIPS 2000 to the external interface module 2150 and receives a security control command and policy from the external interface module 2150. The vIPS framework 2120 receives environment setting values required for its internal modules to perform their functions from the environment setting management module 2140.

The vIPS framework 2120 includes an introspection information collection and analysis module 2121, an IPS control module 2122, an intrusion response module 2123, a policy and signature management module 2124, and a logging module 2125.

The introspection information collection and analysis module 2121 obtains the internal information of the virtual machines and the internal information of the hypervisor 1000 through the hypervisor security API module 2110. In particular, the introspection information collection and analysis module 2121 may provide an analysis of memory content of each virtual machine according to a virtual machine guest OS.

The IPS control module 2122 controls the overall operation of the vIPS 2000. The IPS control module 2122 controls the operation of each of the detection modules (i.e., the stateful firewall module 2200, the NIPS module 2300, and the virtual resource depletion attack detection module 2400).

The intrusion response module 2123 responds to the result of intrusion detection according to a response policy.

The policy and signature management module 2124 manages attack detection signature and response policy rules of the NIPS module 2300 and a firewall policy rule.

The logging module 2125 generates and manages logs.

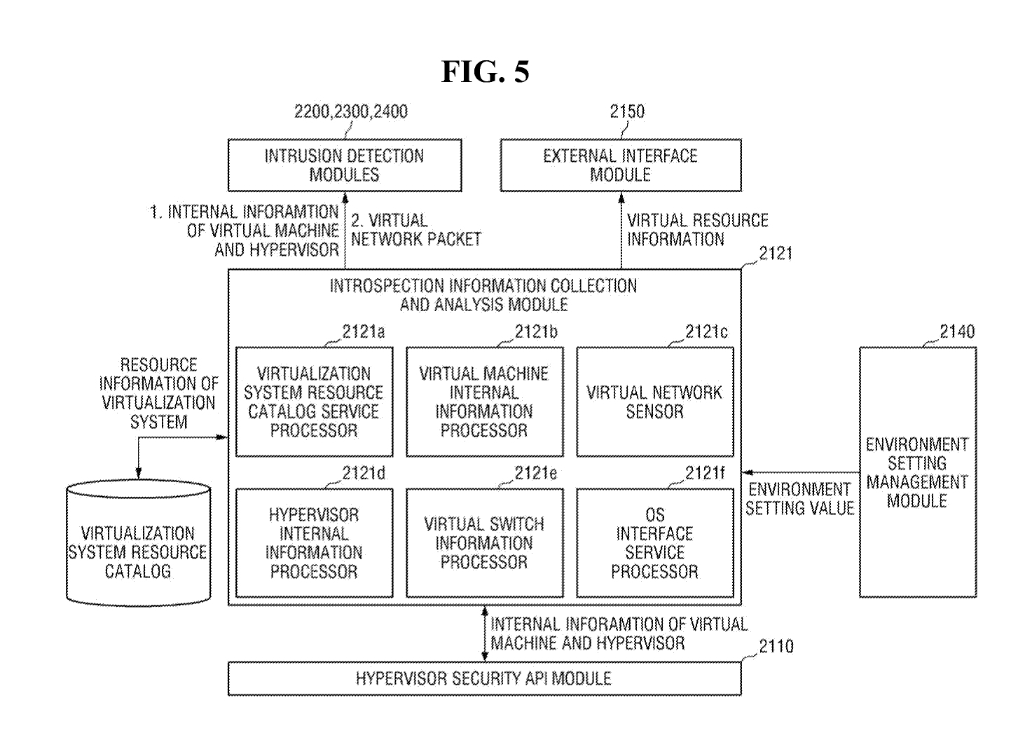

FIG. 5 is a detailed block diagram of the introspection information collection and analysis module 2121 shown in FIG. 4.

Referring to FIG. 5, the introspection information collection and analysis module 2121 collects and analyzes the status information of virtual resources within the virtualization system 10, the internal information of the virtual machines, and the internal information of the hypervisor 1000. The introspection information collection and analysis module 2121 includes a virtualization system resource catalog service processor 2121a, a virtual machine internal information processor 2121b, a virtual network sensor 2121c, a hypervisor internal information processor 2121d, a virtual switch information processor 2121e, and an OS interface service processor 2121f.

The virtualization system resource catalog service processor 2121a builds a catalog by periodically collecting the resource information of the virtualization system 10 and provides a search service for the catalog. The information collection interval (e.g., 10 seconds by default) can be adjusted by an administrator. Alternatively, the virtualization system resource catalog service processor 2121a may not periodically collect information but may be notified whenever the resource information is modified.

The virtual machine internal information processor 2121b may access the internal information of the virtual machines. Virtual network packets are processed by the virtual network sensor 2121c. The internal information of the virtual machines may include virtual hardware specification information (e.g., the number/speed of CPUs, memory capacity, disk capacity, the number/speed of NICs) of the virtual machines and the current internal information (e.g., vCPU register, memory, the status of network use, etc.) of the virtual machines.

The virtual network sensor 2121c obtains a virtual network packet from a virtual network either in an inline mode or a tap mode. The virtual network sensor 2121c may identify the network packet acquisition mode from the environment setting management module 2140 and may be set to the network packet acquisition mode. The virtual network sensor 2121c obtains a virtual network packet through the hypervisor security API module 2110 and sends the virtual network packet to the intrusion detection modules.

The hypervisor internal information processor 2121d may access the internal information of the hypervisor 1000. The internal information of the hypervisor 1000 may include the type (e.g., xenserver, kvm, etc.) of the hypervisor 1000, the version (e.g., citrix xenserver and xen hypervisor information in the case of Xen) of the hypervisor 1000, patch information of the hypervisor 1000, the number/speed of physical CPU cores of the hypervisor 1000, and physical memory of the hypervisor 1000.

The virtual switch information processor 2121e provides internal information of a virtual switch in the current virtualization system 10. The internal information of the virtual switch may include the type (e.g., Open vSwitch, Linux Bridge, etc.) of the virtual switch, the setting status of a bridge, a network access translator (NAT), etc., the setting status of a virtual local area network (VLAN), and the status of a virtual interface.

The OS interface service processor 2121f provides an analysis of memory content (particularly, kernel content) of each virtual machine according to a guest OS. The services provided by the OS interface service processor 2121f may include kernel symbols, window registry reading, etc.

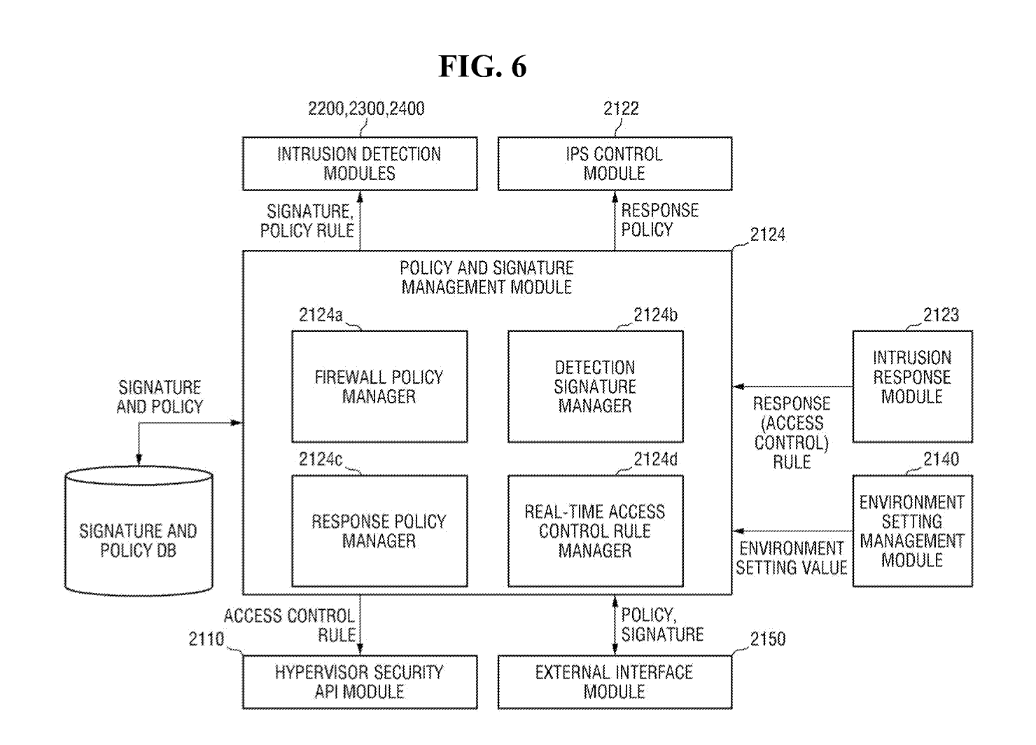

FIG. 6 is a detailed block diagram of the policy and signature management module 2124 shown in FIG. 4.

Referring to FIG. 6, the policy and signature management module 2124 manages policy and attack detection signature rules for the NIPS module 2300 and the stateful firewall module 2200 and provides an API that can be assessed by modules inside and outside the vIPS framework 2120.

The policy rules managed by the policy and signature management module 2124 include policy rules (e.g., a policy rule for policy-based access control) for the stateful firewall module 2200 and signature and policy rules (e.g., a detection signature rule, a response policy rule, etc.) for the NIPS module 2300.

The signature and policy rules managed by the policy and signature management module 2124 may be applied with or without modification to the NIPS module 2300, the stateful firewall module 2200 and the firewall packet filter when the vIPS 2000 starts/restarts, when a signature or policy is added/modified/deleted using an external interface, and when a response action to a certain packet or connection should be performed in response to the detection of an intrusion (when a packet filter for real-time access control should be generated and applied).

The policy and signature management module 2124 includes a firewall policy manager 2124a, a detection signature manager 2124b, a response policy manager 2124c, and a real time access control rule manager 2124d. These managers store and manage policy and signature rules in a signature and policy DB and provide an access service to the policy DB.

The firewall policy manager 2124a manages a policy-based access control rule for the firewall. The detection signature manager 2124b manages an attack detection signature rule for the NIPS module 2300. The response policy manager 2124c manages an attack response policy rule for the NIPS module 2300. The real-time access control rule manager 2124d manages an access control rule that is generated in real time to perform a response action to a certain packet or connection in response to the detection of an intrusion.

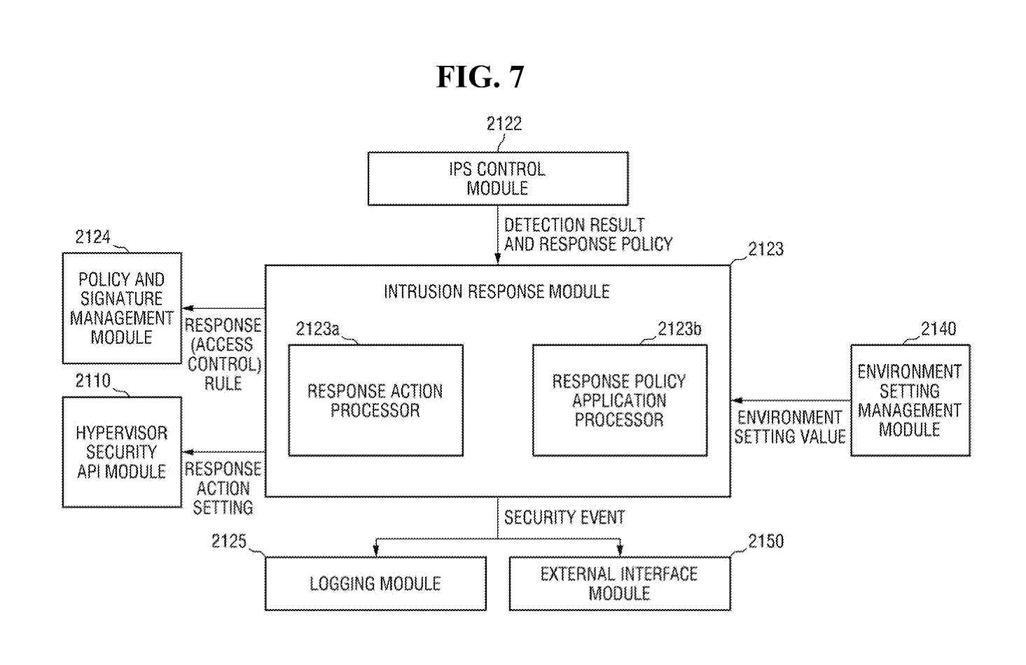

FIG. 7 is a detailed block diagram of the intrusion response module 2123 shown in FIG. 4.

Referring to FIG. 7, the intrusion response module 2123 receives the result of intrusion detection and a response policy from the stateful firewall module 2200, the NIPS module 2300 and the virtual resource depletion attack detection module 2400 and determines a response action to the detection result based on the response policy. The response action determined as described above is performed using the hypervisor security API module 2110 and the policy and signature management module 2124, and the intrusion response module 2123 generates a security event about the above intrusion detection and response by using the logging module 2125.

The intrusion response module 2123 includes a response action processor 2123a and a response policy processor 2123b.

The response action processor 2123a performs a response action planned for an intrusion by using the policy and signature management module 2124 and the hypervisor security API module 2110. The response action processor 2123a generates a security event about an intrusion detection result and response. The response action processor 2123a logs the security event by using the logging module 2125 and transmits the security event to the cloud agent 3000 through the external interface module 2150.

The response policy processor 2123b plans a response action for applying a response policy to a detected intrusion. The response action may include applying a real-time access control rule for access control, limiting the network traffic rate, forwarding network traffic, etc.

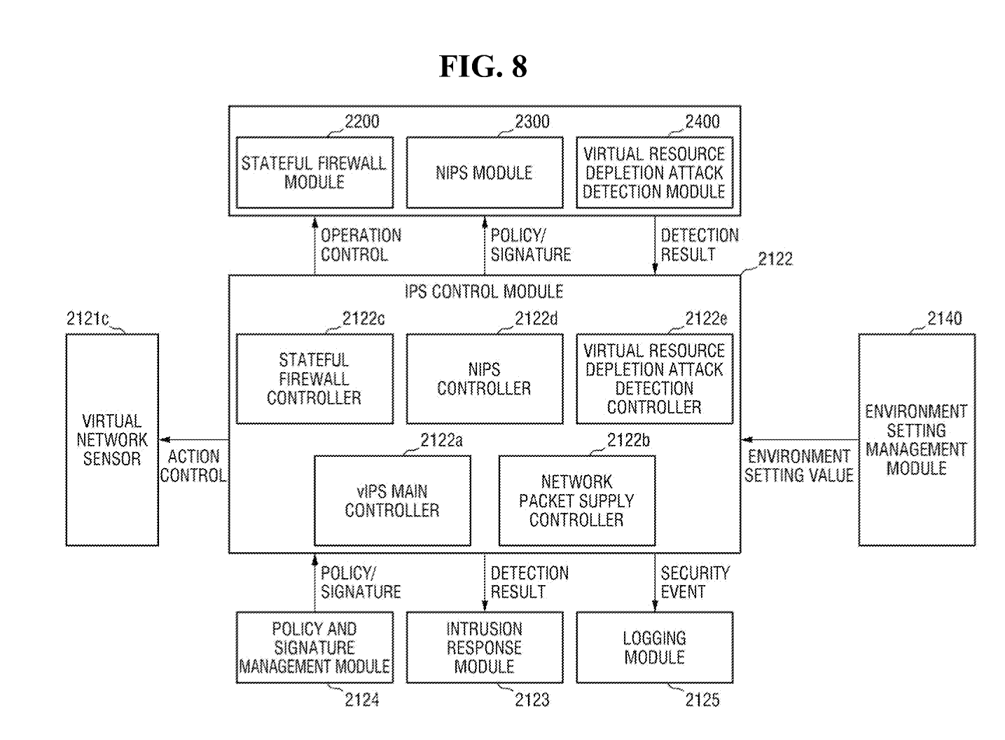

FIG. 8 is a detailed block diagram of the IPS control module 2122 shown in FIG. 4.

Referring to FIG. 8, the IPS control module 2122 controls the overall operation of the vIPS 2000 and controls the operations of the stateful firewall module 2200, the NIPS module 2300 and the virtual resource depletion attack detection module 2400. The IPS control module 2122 includes a vIPS main controller 2122a, a network packet supply controller 2122b, a stateful firewall controller 2122c, a NIPS controller 2122d, and a virtual resource depletion attack detection controller 2122e.

The vIPS main controller 2122a controls the major operations of the vIPS 2000. When the vIPS 2000 runs/restarts, the vPIS main controller 2122a updates environment setting values, a signature rule set, etc. When the vIPS 2000 runs/restarts, the vIPS main controller 2122a controls necessary operations according to the environment setting values and controls policy and signature rule sets of each module to be updated to the latest version by using the controllers of the intrusion detection modules (i.e., the stateful firewall controller 2122c, the NIPS controller 2122d and the virtual resource depletion attack detection controller 2122e).

The vIPS main controller 2122a runs the intrusion detection modules (i.e., the stateful firewall module 2200, the NIPS module 2300 and the virtual resource depletion attack detection module 2400) by using the stateful firewall controller 2122c, the NIPS controller 2122d, and the virtual resource depletion attack detection controller 2122e.

The vIPS main controller 2122a sets the virtual network sensor 2121c to obtain a virtual network packet by using the network packet supply controller 2122b and controls the virtual network sensor 2121c to supply the virtual network packet to the stateful firewall module 2200 and the NIPS module 2300.

The network packet supply controller 2122b controls the supply of a virtual network packet from the virtual network sensor 2121c to the stateful firewall module 2200 and the NIPS module 2300. The network packet supply controller 2122b also controls the supply of a virtual network packet to the virtual network when the vIPS 2000 operates in the inline mode.

The stateful firewall controller 2122c controls the firewall policy rule set update of the stateful firewall module 2200. The stateful firewall controller 2122c controls the stateful firewall module 2200 to operate in response to an injected virtual network packet. The stateful firewall controller 2122c reads stateful firewall-related environment setting values and controls the stateful firewall module 2200 to operate according to the read environment setting values, and controls the initiation and suspension of the stateful firewall.

The NIPS controller 2122d controls the signature and response rule set update of the NIPS module 2300. The NIPS controller 2122d controls the NIPS module 2300 to operate in response to an injected virtual network packet. The NIPS controller 2122 reads NIPS-related environment setting values and controls the NIPS module 2300 to operate according to the read environment setting values, and controls the initiation and suspension of the NIPS.

The virtual resource depletion attack detection controller 2122e controls the operation of the virtual resource depletion attack detection module 2400. The virtual resource depletion attack detection controller 2122e reads environment setting values related to virtual resource depletion attack detection and controls the virtual resource depletion attack detection module 2400 to operate according to the read environment setting values, and controls the initiation and suspension of the virtual resource depletion attack detection module 2400.

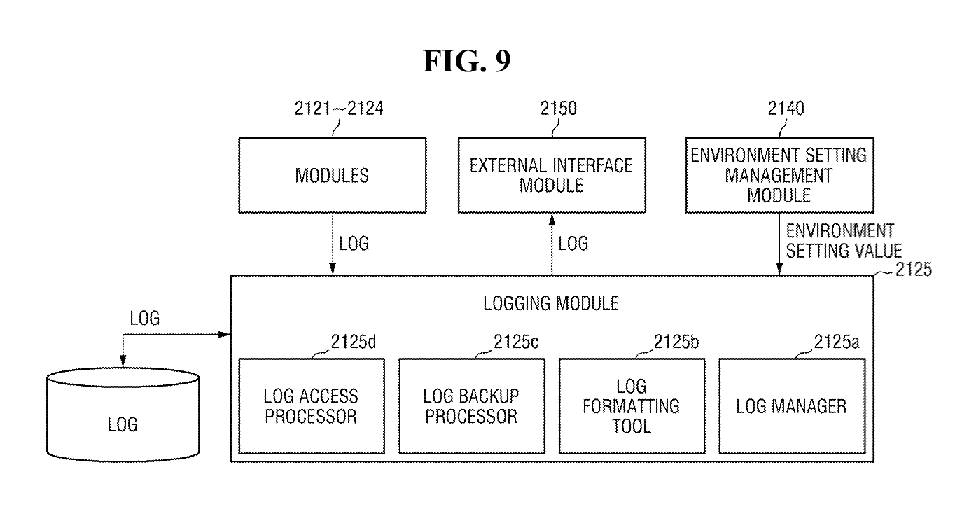

FIG. 9 is a detailed block diagram of the logging module 2125 shown in FIG. 4.

Referring to FIG. 9, the logging module 2125 records a log generated by each module and enables the external interface module 2150 to read or back up the log. The logging module 2125 includes a log manager 2125a, a log formatting tool 2125b, a log backup processor 2125c, and a log access processor 2125d.

The log manager 2125a manages the location, filename, etc. to which a log should be stored by referring to environment setting variables.

The log backup processor 2125c backs up a stored log file to a desired location.

The log formatting tool 2125b, when receiving log content from each module, formats the received log content into a real log message that can be stored in a storage space by the log access processor 2125d.

The log access processor 2125d reads and writes a log from or to a disk (or another form of storage). The log access processor 2125d can immediately write a log to the storage space without buffering.

In a security event, traffic information may be traffic information that is provided from Open vSwitch to Netflow, a security alarm may be an event that matches IPS and firewall rules and is set to generate an alarm, and a security log may be an event that matches the IPS and firewall rules but is set to be logged without generating an alarm. In a system event, a system log may be an event related to a system operation generated by each module of the vIPS 2000.

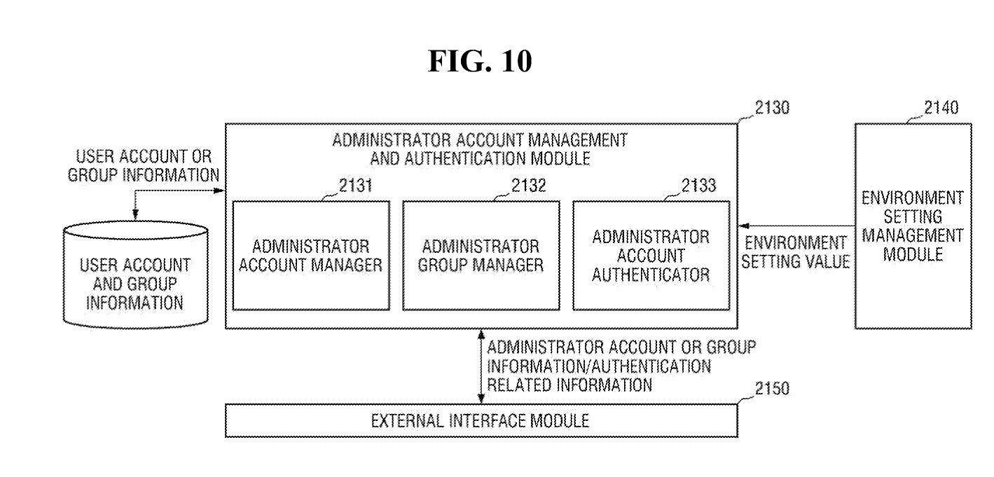

FIG. 10 is a detailed block diagram of the administrator account management and authentication module 2130 shown in FIG. 2.

Referring to FIG. 10, the administrator account management and authentication module 2130 manages administrator accounts and authenticates administrators. The administrator account management and authentication module 2130 includes an administrator account manager 2131, an administrator group manager 2132, and an administrator account authenticator 2133.

The administrator account manager 2131 manages administrator accounts and provides access (read, write) to account information through the external interface module 2150. Information about an administrator account may include an administrator ID, an administrator group, a password, rights (rights of the administrator group are inherited, and other additional rights only are managed by the administrator account manager 2131), an administrator name, and other information.

The administrator group manager 2132 manages administrator groups. Information about an administrator group may include the name, rights, etc. of the administrator group.

The administrator account authenticator 2133 authenticates an administrator account based on an administrator's account ID and password.

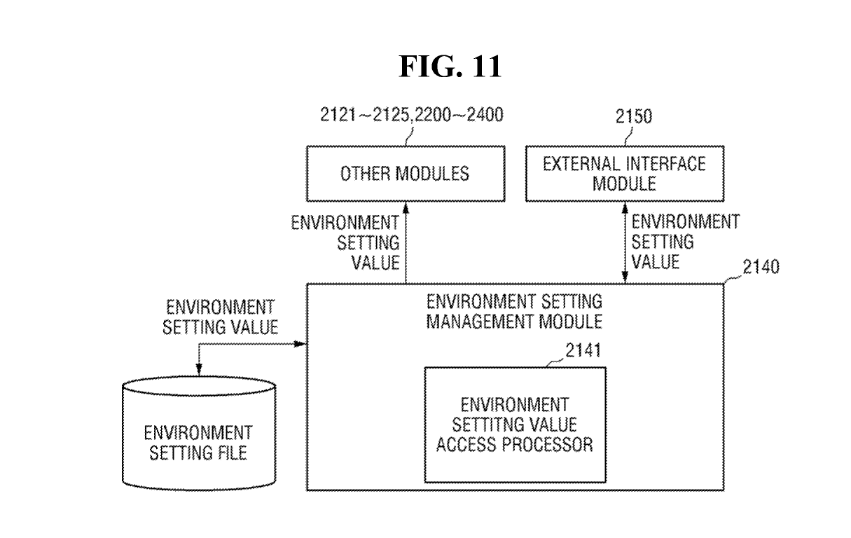

FIG. 11 is a detailed block diagram of the environment setting management module 2140 shown in FIG. 2.

Referring to FIG. 11, the environment setting management module 2140 manages environment setting values and inputs/outputs the environment setting values. The environment setting management module 2140 includes an environment setting value access processor 2141.

The environment setting value access processor 2141 guarantees mutual exclusivity when the environment setting values are input and output. Therefore, while the environment setting values are being changed, it is not possible to read only some changed values. The environment setting value access processor 2141 provides an interface to which the environment setting values can be written through the external interface module 2150. The environment setting value access processor 2141 provides an interface through which other modules in the vIPS 2000 can read the environment setting values.

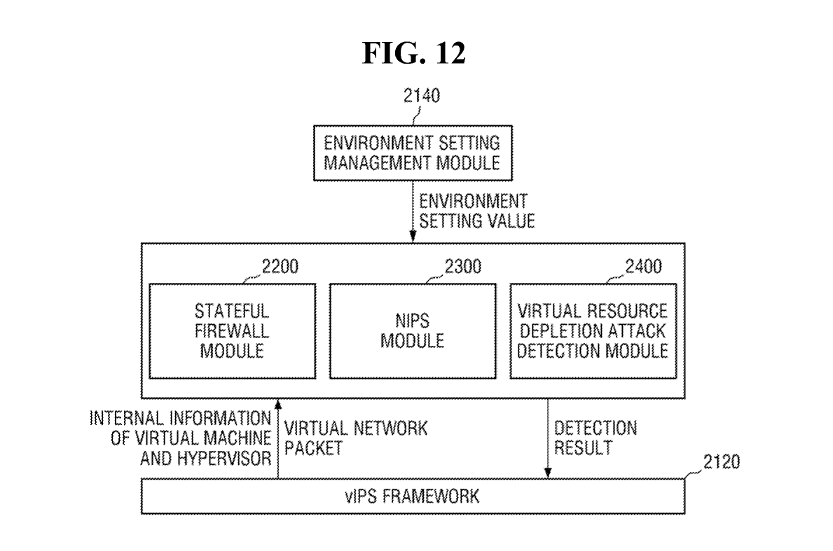

FIG. 12 is a diagram illustrating the operations of the intrusion detection modules shown in FIG. 2.

Referring to FIG. 12, the stateful firewall module 2200, the NIPS module 2300, and the virtual resource depletion attack detection module 2400 perform intrusion detection by interpreting/applying the access control policy and attack detection signature rules for the virtualization system 10 and send the result of intrusion detection to the vIPS framework 2120, so that the vIPS framework 2120 performs a response action according to a response policy.

The intrusion detection modules (i.e., the stateful firewall module 2200, the NIPS module 2300, and the virtual resource depletion attack detection module 2400) may operate in any of the following two modes.

In the inline mode, the vIPS 2000 is involved in the flow of virtual network packets inline. Therefore, all virtual network packets that pass through the virtual switch are switched by the virtual switch to their destinations over the virtual network only when they successfully pass through both a firewall module (the firewall packet filter and the stateful firewall) and the NIPS module 2300. However, network packets on a whitelist are immediately passed and switched to their destinations.

In the tap mode, the flow of virtual network packets is tapped (mirrored). Therefore, network packets generated redundantly are supplied to the vIPS 2000. Before being tapped, packets not dropped by the firewall packet filter which applies access control are switched to their destinations. Also, the packets are tapped, and duplicate copies of the packets are sent to the vIPS 2000 and the stateful firewall module 2200. From among a plurality of network packets to be mirrored, network packets on a whitelist are not supplied to the stateful firewall module 2200 and the NIPS module 2300.

The flow of virtual network packets according to the operation mode is as follows. First, all network packets on the virtual network pass through the firewall packet filter. The network packets that pass through the firewall packet filter are broadly divided into packets that are dropped, packets that are passed because they are on a whitelist, and packets that are not dropped nor bypassed.

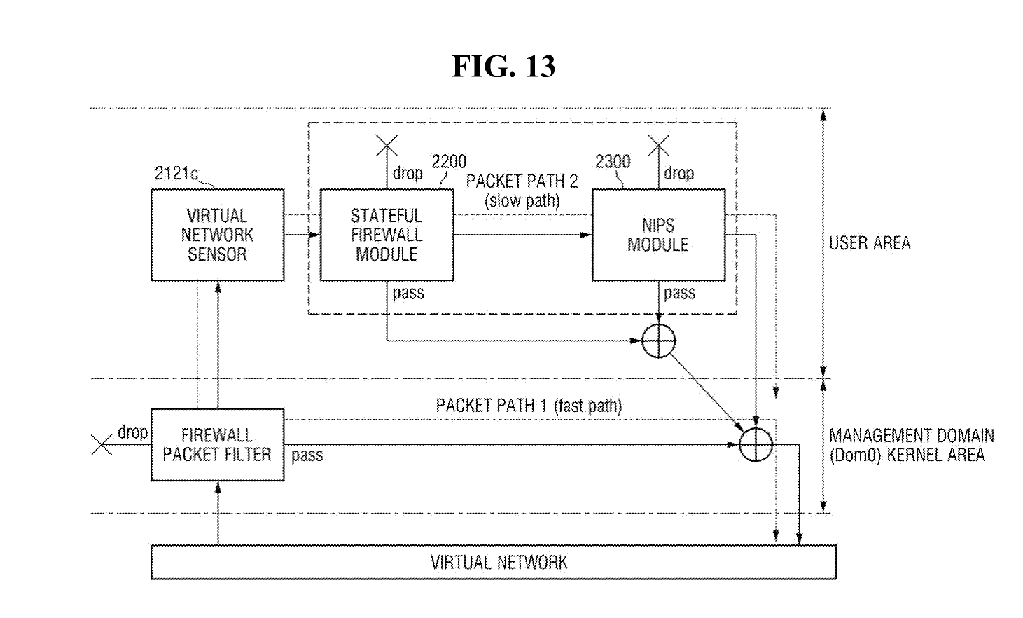

FIG. 13 is a diagram illustrating the flow of virtual network packets in the inline mode.

Referring to FIG. 13, in the inline mode, two types of packets not dropped by the firewall packet filter are moved along the following two paths.

Packets that are bypassed because they are on a whitelist are moved along packet path 1 (fast path). These packets are sent to the virtual machines within the virtualization system 10 or to the outside of the virtualization system 10 according to their destinations. In this case, since the packets are processed only in a management domain kernel area, they are rapidly switched to their destinations (fast path). Therefore, whitelisted network packets that do not need to be inspected by the vIPS 2000 can surely be processed at high speed.

Packets that are not dropped nor passed are moved along packet path 2 (slow path). These packets are collected by the virtual network sensor 2121c to pass through the stateful firewall module 2200 and the NIPS module 2300. When any one of the packets is detected as an intrusion by the stateful firewall module 2200 and the NIPS module 2300, a response action is applied (for example, the packet is dropped) according to a response policy. Network packets on a whitelist set by the stateful firewall module 2200 or the NIPS module 2300 are immediately passed and sent to the virtual machines within the virtualization system 10 or to the outside of the virtualization system 10 according to their destinations. Since the packets have to pass through a user area, they are moved along a relatively slow path (slow path).

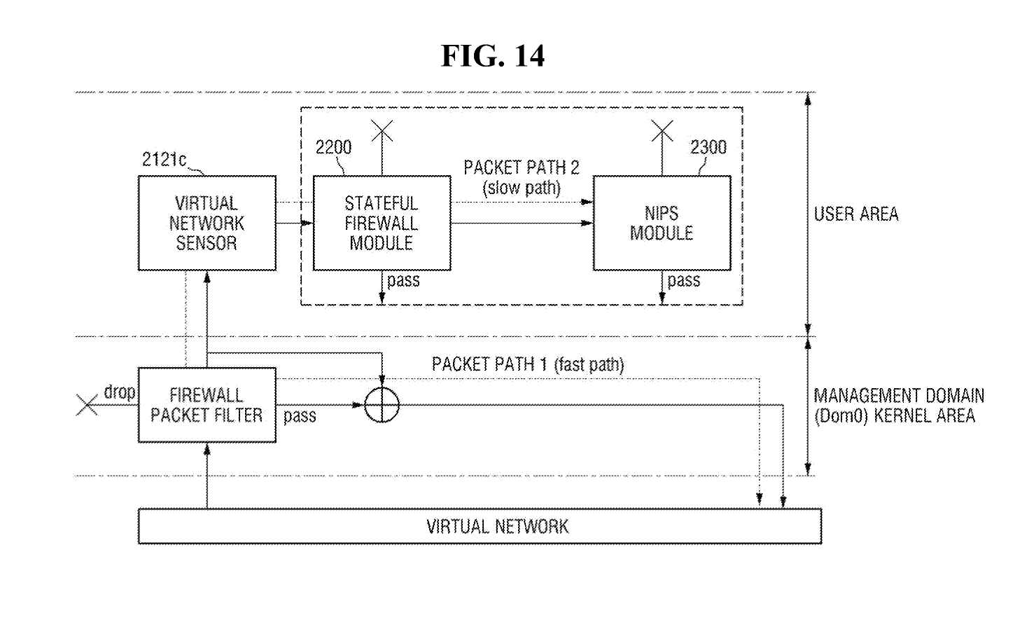

FIG. 14 is a diagram illustrating the flow of virtual network packets in the tap mode.

Referring to FIG. 14, in the tap mode, two types of packets not dropped by the firewall packet filter are moved along the following two paths.

Packets excluding dropped packets are moved along packet path 1 (fast path). These packets are sent to the virtual machines within the virtualization system 10 or to the outside of the virtualization system 10 according to their destinations. In this case, since the packets are processed only in the management domain kernel area, they are rapidly switched to their destinations (fast path). Therefore, whitelisted network packets that do not need to be inspected by the vIPS 2000 can surely be processed at high speed.

Packets that are not dropped nor passed are duplicated and moved along packet path 2 (slow path). These packets are collected by the virtual network sensor 2121c to pass through the stateful firewall module 2200 and the NIPS module 2300. When any one of the packets is detected as an intrusion by the stateful firewall module 2200 and the NIPS module 2300, a response action is applied (for example, the connection is interrupted or the traffic rate is reduced) according to a response policy. Network packets on a whitelist set by the stateful firewall module 2200 or the NIPS module 2300 are immediately passed without being inspected by the stateful firewall module 2200 or/and the NIPS module 2300. Since the packets have to pass through the user area, they are moved along a relatively slow path (slow path).

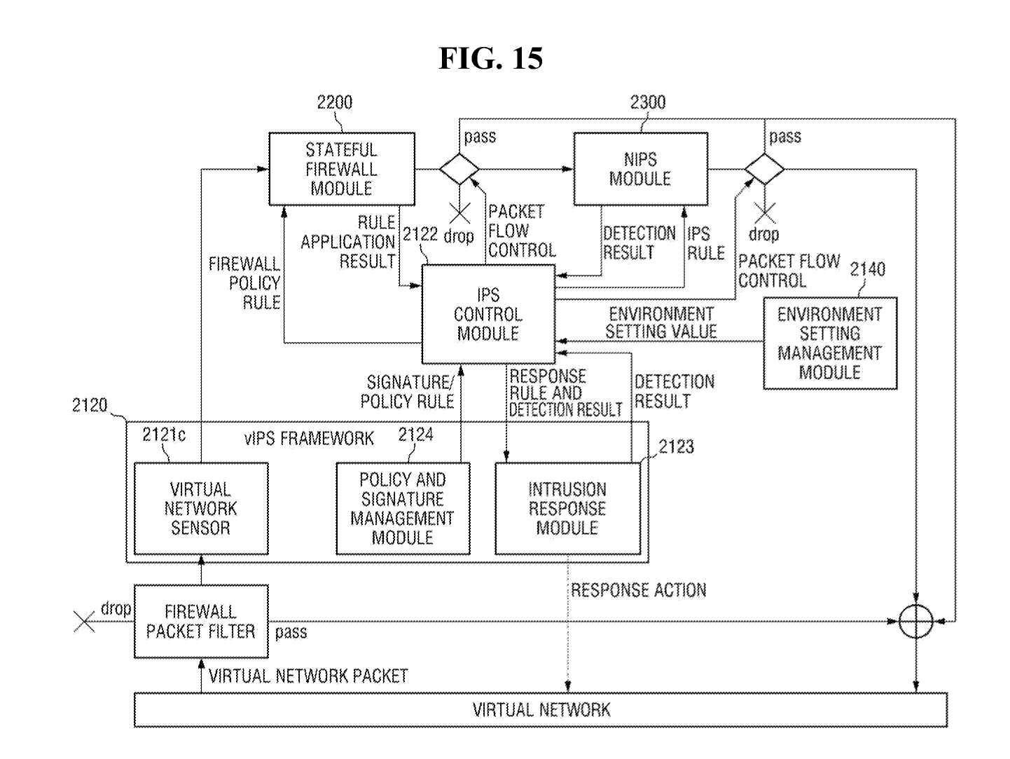

FIG. 15 is a diagram illustrating the detailed operations of the stateful firewall module 2200 and the NIPS module 2300 in the inline mode.

Referring to FIG. 15, in the inline mode, the IPS control module 2122 accesses the latest firewall policy and the latest NIPS signature through the policy and signature management module 2124 and provides them to the stateful firewall module 2200 and the NIPS module 2300, respectively. Then, the IPS control module 2122 initiates the operations of the stateful firewall module 2200, the NIPS module 2300 and the virtual network sensor 2121c. All virtual network packets on the virtual network are filtered by the firewall packet filter before being sent to the virtual network sensor 2121c. Here, virtual network packets that are not dropped nor passed by the firewall packet filter is collected by the virtual network sensor 2121c.

Then, the functions of the stateful firewall and the NIPS are applied to the virtual network packets collected by the virtual network sensor 2121c. The process of supplying a network packet to the stateful firewall module 2200 and the NIPS module 2300 and determining the next flow of the network packet based on the intrusion detection result of the stateful firewall module 2200 and the NIPS module 2300 is controlled by the IPS control module 2122. Specifically, a packet collected by the virtual network sensor 2121c is first provided to the stateful firewall module 2200. Then, the stateful firewall module 2200 sends the result of rule application to the IPS control module 2122. The IPS control module 2122 immediately sends the packet to the virtual network when the rule application result of the stateful firewall module 2200 is ‘pass,’ drops the packet when the rule application result is ‘drop,’ and provides the packet to the NIPS module 2300 when the rule application result is not ‘pass’ nor ‘drop.’

The NIPS module 2300 performs pattern matching on a received network packet by using the signature rule and provides the result of pattern matching to the IPS control module 2122. The IPS control module 2122 performs the following actions based on the result provided by the NIPS module 2300.

When the result matches the detection signature rule, the IPS control module 2122 provides this detection result to the intrusion response module 2123, so that the intrusion response module 2123 performs a response action according to a relevant response policy. In this case, the connection may be interrupted, the packet may be forwarded, or the traffic rate may be adjusted. When the packet should be dropped, the IPS control module 2122 prevents the packet from being sent to the virtual network and thus to its final destination.

When the result is ‘pass’ or does not match the detection signature rule, the IPS control module 2122 sends the packet to the virtual machines within the virtualization system 10 or to the outside of the virtualization system 10 according to its destination by using the virtual switch.

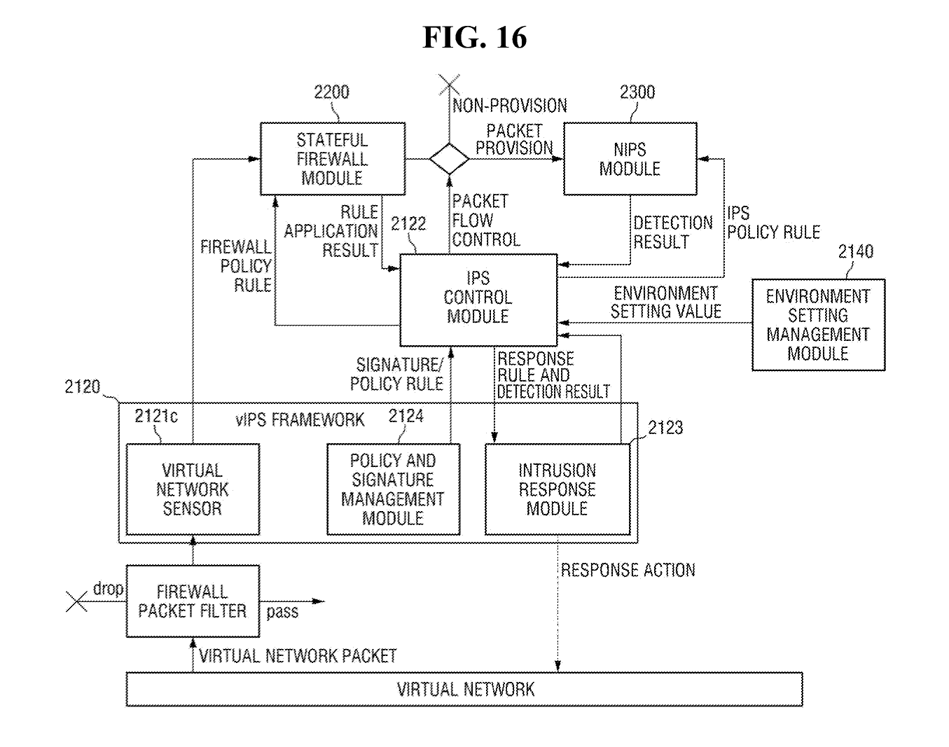

FIG. 16 is a diagram illustrating the detailed operations of the stateful firewall module 2200 and the NIPS module 2300 in the tap mode.

Referring to FIG. 16, in the tap mode, the IPS control module 2122 accesses the latest firewall policy and the latest NIPS signature through the policy and signature management module 2124 and provides them to the stateful firewall module 2200 and the NIPS module 2300, respectively. Then, the IPS control module 2122 initiates the operations of the stateful firewall module 2200, the NIPS module 2300 and the virtual network sensor 2121c. All virtual network packets on the virtual network are filtered by the firewall packet filter before being sent to the virtual network sensor 2121c. Of the virtual network packets that pass through the firewall packet filter, packets that are passed and packets that are not dropped are sent to the virtual machines within the virtualization system 10 or to the outside of the virtualization system 10 according to their destinations by using the virtual switch. Duplicate copies of network packets that are not passed nor dropped are sent to the virtual network sensor 2121c.

Then, the functions of the stateful firewall and the NIPS are applied to the packets sent to the virtual network sensor 2121c. The process of supplying a network packet to the stateful firewall module 2200 and the NIPS module 2300 and determining the next flow of the network packet based on the intrusion detection result of the stateful firewall module 2200 and the NIPS module 2300 is controlled by the IPS control module 2122. Specifically, a packet collected by the virtual network sensor 2121c is first provided to the stateful firewall module 2200. Then, the stateful firewall module 2200 sends the result of rule application to the IPS control module 2122.

When the rule application result of the stateful firewall module 2200 does not match the firewall policy rule, the IPS control module 2122 sends the packet to the NIPS module 2300. When the rule application result of the stateful firewall module 2200 matches the firewall policy rule, the IPS control module 2122 provides this intrusion detection result and a corresponding response rule to the intrusion response module 2122, so that the intrusion response module 2122 performs a response action. In this case, the packet is not provided to the NIPS module 2300.

The NIPS module 2300 applies the signature rule to a received packet and provides the result of rule application to the IPS control module 2122. The IPS control module 2122 provides this intrusion detection result and a corresponding response rule to the intrusion response module 2122, so that the intrusion response module 2122 performs a response action according to a relevant response policy.

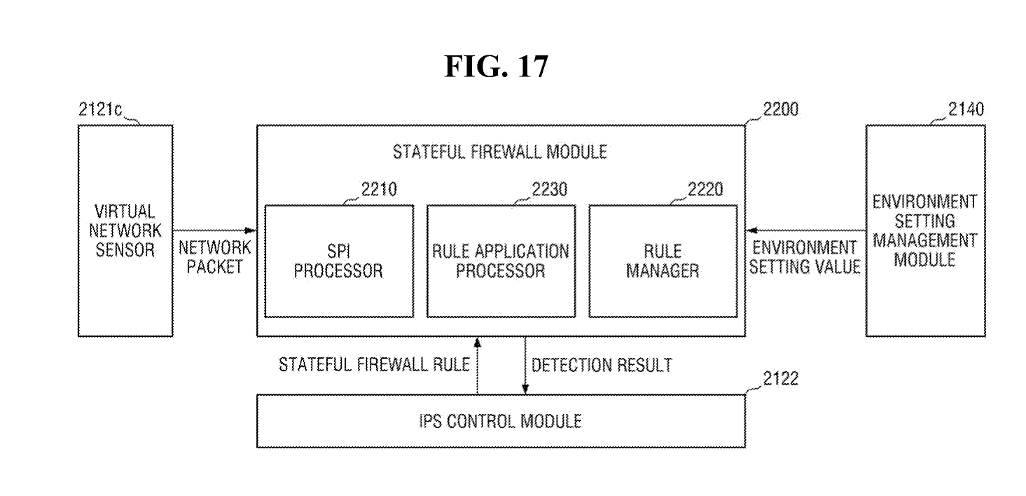

FIG. 17 is a detailed block diagram of the stateful firewall module 2200 shown in FIG. 2.

Referring to FIG. 17, the stateful firewall module 2200 functions as a stateful firewall engine. The stateful firewall module 2200 includes a stateful packet inspection (SPI) processor 2210, a rule manager 2220, and a rule application processor 2230.

The SPI processor 2210 performs SPI.

The rule manager 2220 manages a firewall policy rule obtained through the IPS control module 2122.

The rule application processor 2230 inspects whether the result of SPI matches the stateful firewall rule. When the result of SPI matches the stateful firewall rule, the rule application processor 2230 notifies the IPS control module 2122 of this detection result, generates a security event using a corresponding module, and logs the security event using the logging module 2125.

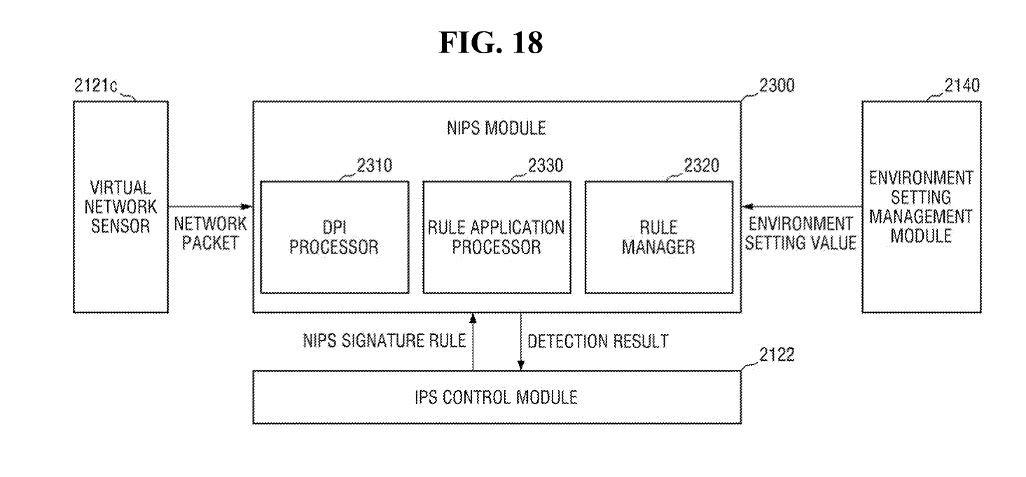

FIG. 18 is a detailed block diagram of the NIPS module 2300 shown in FIG. 2.

Referring to FIG. 18, the NIPS module 2300 functions as a NIPS engine. The NIPS module 2300 includes a deep packet inspection (DPI) processor 2310, a rule manager 2320, and a rule application processor 2330.

The DPI processor 2310 performs DPI.

The rule manager 2320 manages a NIPS signature rule obtained through the IPS control module 2122.

The rule application processor 2330 inspects whether the pattern of a network packet and the result of DPI match the NIPS signature rule. When the pattern of the network packet and the result of SPI match the NIPS signature rule, the rule application processor 2330 notifies the IPS control module 2122 of this detection result, generates a security event using a corresponding module, and logs the security event using the logging module 2125.

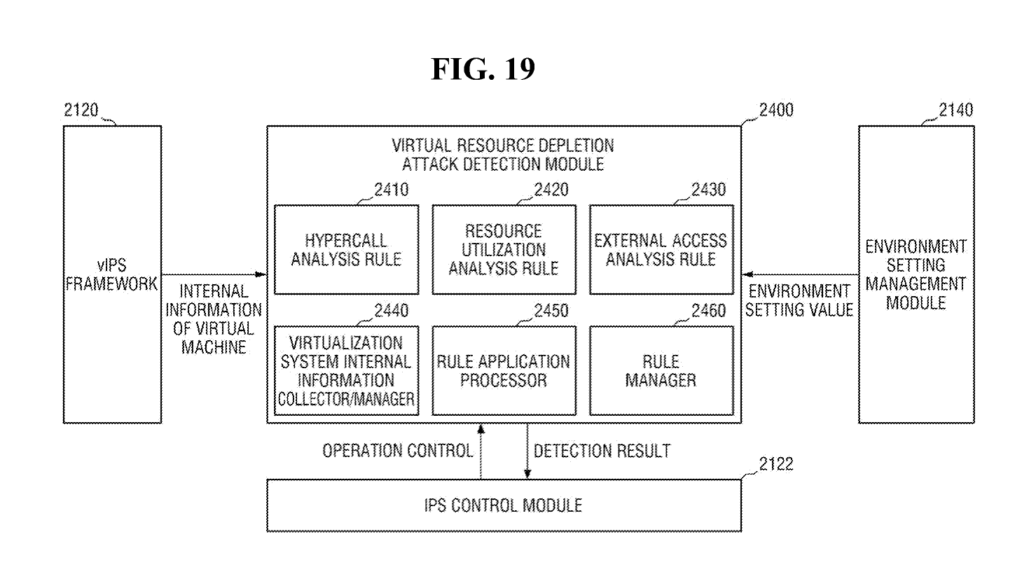

FIG. 19 is a detailed block diagram of the virtual resource depletion attack detection module 2400 shown in FIG. 2.

Referring to FIG. 19, the virtual resource depletion attack detection module 2400 performs matching test of the resource depletion attack with a signature rule set for detecting a resource depletion attack on the virtualization system 10. The virtual resource depletion attack detection module 2400 may detect a denial of service (DoS) attack by analyzing the behavior of calling hypercalls and the status of resource utilization by the virtualization system 10. The virtual resource depletion attack detection module 2400 may also detect a distributed denial of service (DDoS) attack from the outside.

The virtual resource depletion attack detection module 2400 includes a hypercall analysis rule 2410, a resource utilization analysis rule 2420, an external access analysis rule 2430, an information collector/manager 2440, a rule application processor 2450, and a rule manager 2460.

The hypercall analysis rule 2410 may include a rule based on a quantitative analysis of hypercalls called (e.g., the number of hypercalls called per unit of time by each virtual machine) and a rule based on a qualitative analysis of hypercalls called (e.g., the number of times that a certain hypercall is called per unit of time by each virtual machine). The rules based on the analysis for status of hypercalls called are judged in relation to the current load on the virtualization system 10.

The resource utilization analysis rule 2420 may include a rule based on an analysis of network traffic (e.g., the network traffic load and pattern of each virtual machine per unit of time), a rule based on an analysis of storage access (e.g., the storage access pattern of each virtual machine per unit of time) and a rule based on an analysis of memory use (e.g., the memory thrashing status of each virtual machine per unit of time). The rules based on the analysis for resource utilization are judged in relation to the current load on the virtualization system 10.

The external access analysis rule 2430 may include a rule based on an analysis of the status of host IPs accessed by the virtual machines (e.g., the status of a host being accessed by each virtual machine), a rule based on an analysis of abnormal access behaviors of the virtual machines (e.g., abnormal network protocol execution by each virtual machine), and a rule based on an analysis of the connection between the status of the hosts accessed by the virtual machines and the abnormal behaviors of the virtual machines.

The information collector/manager 2440 collects and manages the internal information of the virtual machines within the virtualization system 10 and the internal information of the hypervisor 1000 through the vIPS framework 2120. The information collector/manager 2440 extracts a list of internal information required by rule sets and then obtains only necessary information from the extracted information and manages the obtained information.

The rule manager 2460 manages the rule sets.

The rule application processor 2450 inspects whether the internal information of the virtualization system 10 matches virtual resource depletion attack signature rules. The virtual resource depletion attack signature rules include the hypercall analysis rule 2410, the resource utilization analysis rule 2420, and the external access analysis rule 2430. When the internal information of the virtualization system 10 matches the virtual resource depletion attack signature rules, the rule application processor 2450 notifies the IPS control module 2122 of this detection result, generates a security event using a corresponding module, and logs the security event using the logging module 2125.

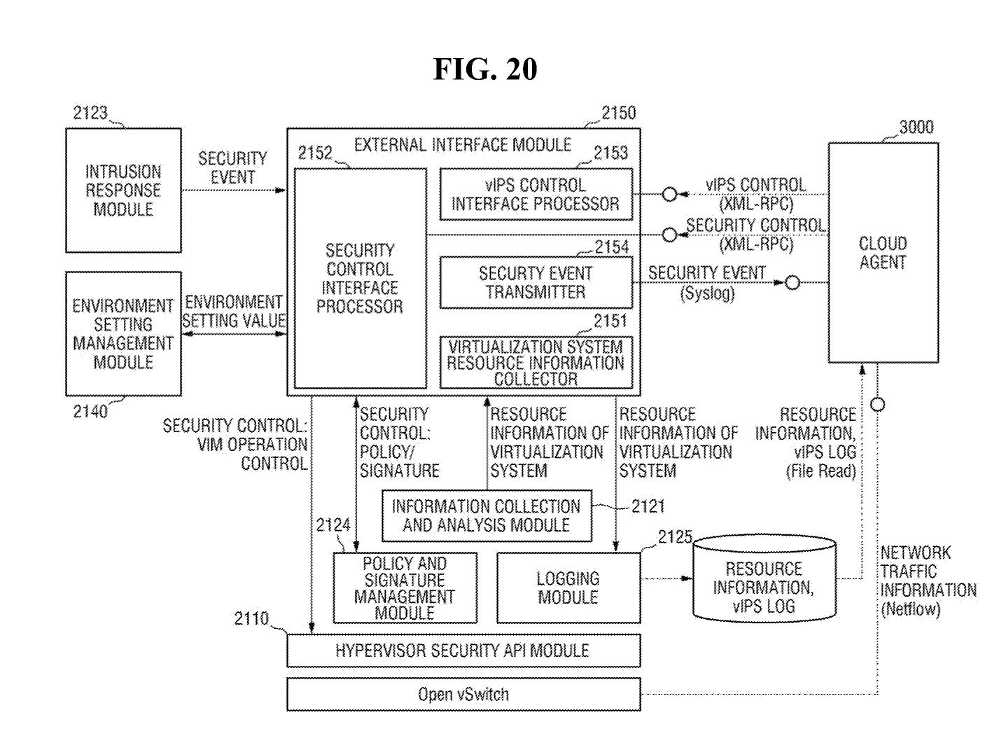

FIG. 20 is a detailed block diagram of the external interface module 2150 shown in FIG. 2.

Referring to FIG. 20, the external interface module 2150 provides external interfaces for linkage with the cloud agent 3000 and other external devices.

The external interfaces include a virtualization system resource information interface (in the form of a log file), a security event interface (in the form of Syslog), a network traffic information interface (in the form of Netflow), a security control interface (in the form of XML-RPC), and a vIPS control interface (in the form of XML-RPC).

The external interface module 2150 includes a virtualization system resource information collector 2151, a security control interface processor 2152, and a vIPS control interface processor 2153.

The virtualization system resource information collector 2151 periodically collects the resource information of the virtualization system 10 by using the introspection information collection and analysis module 2121 and records the collected information on a disk in the form of a log file.

The security control interface processor 2152 provides the cloud agent 3000 with an XML-RPC API as the security control interface and executes a security control command called by the cloud agent 3000 through the hypervisor security API module 2110.

The vIPS control interface processor 2153 provides the cloud agent 3000 with an XML-RPC API as the vIPS control interface. The vIPS control interface processor 2153 provides environment setting values of the vIPS 2000 queried by the cloud agent 3000 and executes a vIPS control command called by the cloud agent 3000.

A security event transmitter 2154 provides the security event interface to the cloud agent 3000. The security event interface may provide a security event generated by the vIPS 2000 using a Syslog protocol.

The network traffic information interface may be provided by Open vSwitch in the case of XenServer and by vSphere in the case of VMware. Since XenServer uses HTTPS over port 443 for XenAPI, the vIPS control interface may communicate over HTTPS using another port. The vIPS control interface may also use HTTP for the cloud agent 3000 which exists in the same server as the vIPS 2000.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A hypervisor-based intrusion prevention platform comprising:
a virtual network intrusion prevention system (vIPS) framework which obtains internal information of a virtualization system from a hypervisor and performs security control on the hypervisor in response to the result of intrusion detection carried out by using the internal information of the virtualization system;
a hypervisor security application programming interface (API) module which provides an API used by the vIPS framework to access the hypervisor;
an administrator account management and authentication module which manages an administrator account of a vIPS and authenticates the administrator account;
an environment setting management module which manages environment setting values of modules within the vIPS; and
an external interface module which provides an interface for system control and security control.

2. The platform of claim 1, wherein the vIPS framework comprises an introspection information collection and analysis module which obtains internal information of a virtual machine, internal information of the hypervisor, and a virtual network packet of the virtualization system from the hypervisor.

3. The platform of claim 1, wherein the vIPS framework comprises an intrusion response module which determines a response action corresponding to the result of intrusion detection based on a response policy.

4. The platform of claim 1, wherein the vIPS framework comprises a policy and signature management module which manages a firewall policy rule, a detection signature rule, a response policy rule, and a real-time access control rule.

5. The platform of claim 1, wherein the vIPS framework comprises a logging module which generates and manages a log.

6. The platform of claim 1, wherein the internal information of the virtualization system comprises the internal information of the virtual machine, the internal information of the hypervisor, and the virtual network packet of the virtualization system.

7. The platform of claim 1, wherein the security control comprises operation control of the virtual machine and rate control of virtual network traffic.

8. A hypervisor-based vIPS comprising:
intrusion detection modules which perform intrusion detection by using internal information of a virtual machine, internal information of a hypervisor, and a virtual network packet of a virtualization system; and
a hypervisor-based intrusion prevention platform which provides the internal information of the virtual machine, the internal information of the hypervisor and the virtual network packet of the virtualization system to the intrusion detection modules and receives the result of intrusion detection from the intrusion detection modules,
wherein the hyper-based intrusion prevention platform comprises:
a vIPS framework which obtains the internal information of the virtual machine, the internal information of the hypervisor and the virtual network of the virtualization system from the hypervisor and performs operation control of the virtual machine and rate control of virtual network traffic on the hypervisor in response to the result of intrusion detection;
a hypervisor security API module which provides APIs used by the vIPS framework to access the hypervisor;
an administrator account management and authentication module which manages an administrator account of the vIPS and authenticates the administrator account;
an environment setting management module which manages environment setting values of modules within the vIPS; and
an external interface module which provides interfaces for system control and security control.

9. The vIPS of claim 8, wherein the vIPS framework comprises an introspection information collection and analysis module which obtains the internal information of the virtual machine, the internal information of the hypervisor, and the virtual network packet of the virtualization system from the hypervisor.

10. The vIPS of claim 8, wherein the vIPS framework comprises an intrusion response module which determines a response action corresponding to the result of intrusion detection based on a response policy.

11. The vIPS of claim 8, wherein the vIPS framework comprises a policy and signature management module which manages a firewall policy rule, a detection signature rule, a response policy rule, and a real-time access control rule.

12. The vIPS of claim 8, wherein the vIPS framework comprises a logging module which generates and manages a log.

13. The vIPS of claim 8, wherein the intrusion detection modules comprise a stateful firewall module which functions as a stateful firewall engine, wherein the stateful firewall module performs intrusion detection by performing stateful packet inspection on a virtual network packet.

14. The vIPS of claim 8, wherein the intrusion detection modules comprise a network-based IPS (NIPS) which functions as a NIPS engine, wherein the NIPS module performs intrusion detection by performing deep packet inspection on a virtual network packet.

15. The vIPS of claim 8, wherein the intrusion detection modules comprise a virtual resource depletion attack detection module which detects a resource depletion attack on virtual resources, wherein the virtual resource depletion detection module performs intrusion detection by analyzing the behavior of calling hypercalls and the status of resource utilization by the virtualization system.
